(19) United States
(12) Patent Application Publication
(10) Pub. No.: US 2026/0059499 A1
(43) Pub. Date: Feb. 26, 2026

(54) RRM MOBILITY REPORTING BASED ON BEAM MANAGEMENT MEASUREMENTS

(71) Applicant: Telefonaktiebolaget LM Ericsson (publ), Stockholm (SE)

(72) Inventors: Dino PJANIC, Malmö (SE); Alexandros SOPASAKIS, Onsala (SE); Andres REIAL, Höllviken (SE); Icaro Leonardo DA SILVA, Solna (SE)

(21) Appl. No.: 19/105,978

(22) PCT Filed: Sep. 6, 2023
(86) PCT No.: PCT/EP2023/074503

§ 371 Date: Feb. 24, 2025

Related U.S. Application Data
(60) Provisional application No. 63/404,283, filed on Sep. 7, 2022.

(51) Int. Cl. H04W 72/04; H04W 24/10

(52) U.S. Cl. CPC H04W 72/04; H04W 24/10

(57) ABSTRACT

A method, system and apparatus are disclosed. At least one embodiment includes a wireless device, WD, configured to communicate with a network node. the WD is configured to, and/or includes a radio interface and/or processing circuitry configured to receive a radio resource management, RRM, report configuration. The wireless device is further configured to estimate at least one RRM metric for each of a first cell and second cell based on Layer 1, L1, measurement, e.g., a beam management, BM, measurement, of the first cell and a pre-determined relationship between the L1 measurement and at least one RRM measurement The wireless device is further configured to perform a RRM procedure based on the estimated at least one RRM metric and the RRM report configuration.

### FIELD

The present disclosure relates to wireless communications, and in particular, to radio resource management (RRM) reporting and/or procedures.

### INTRODUCTION

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

### Conventional RRM Measurements and Reporting

The wireless device is configured with event-based reporting, and the wireless device transmits one or more radio resource management (RRM) reports (triggered by events). The network node determines whether handover (HO) is necessary, and if so, triggers a HO.

### ML-Enhanced RRM Measurements:

The wireless device can learn imminent event/HO situations based on previous RRM measurements. In regular operation, the experience of learned RRM measurements for candidate cells and temporal sequences relationships is combined with current RRM measurements to improve (e.g., make more robust) RRM measurement and event reports

### Conditional HO:

The wireless device is configured with an RRM measurement condition for initiating a HO to another cell and/or network node, and the cell and/or network node is informed by the current serving cell and/or network node about an imminent HO. If the wireless device detects that the condition is satisfied, it autonomously accesses and connects to the new serving cell.

In conventional RRM measurements and reporting, HO is triggered based on RRM mobility events that a wireless device directly observes and reports to the network node. This may in some scenarios lead to lack of robustness if the RRM measurement rate is relatively slow, but the current link deteriorates rapidly around the time when the event is reported. RRM measurements consume wireless device energy.

Using ML-enhanced RRM measurements, robustness may be improved but full RRM measurements by the wireless device are still necessary, meaning also full energy consumption in the wireless device.

With conditional HO, reporting by the wireless device is minimized but the full measurements continue, and the resulting HO robustness may be lower since the HO decision is taken by the wireless device based on one or a few individual measurements.

Hence, existing RRM measurements are not without issues.

### SUMMARY

Aspects are provided in the independent claims, and embodiments thereof are provided in the dependent claims.

Some embodiments advantageously provide methods, systems, and apparatuses for radio resource management (RRM) reporting and/or procedures.

One or more embodiments provide a RRM reporting approach where the wireless device can minimize RRM measurements and the RRM report contents are robust.

According to one or more embodiments, during a learning phase, a wireless device establishes a relationship between L1 measurements (e.g., BM CSI-RS) for the serving cell and corresponding RRM measurement results (e.g., SSB-based) for the serving and additional neighbor cells. This may be achieved, e.g., by training an ML model or preparing lookup tables

In regular operation, the wireless device continually performs BM measurements for the serving cell and uses these reports as input [to ML inference] to estimate RRM cell/beam quality metrics for the serving and other cells, or to estimate RRM event occurrences. In particular, using the ML model approach, the RRM metric prediction can include consideration of wireless device trajectory, which results in better estimates compared to traditional individual event or other RRM measurement reporting.

The wireless device may be configured by the network node with conventional event-based reporting and uses the estimated RRM metrics and related event criterion evaluations as input to such RRM reporting.

In regular operation in (typical) setups where the CSI-RS occasions are distinct from SSB occasions, the wireless device omits RRM measurements, or performs such measurements only sparsely/occasionally. The wireless device may keep at least the RF stage in a low-power state during the conventional RRM measurement occasions, or at least a part of it corresponding to other other-cell measurements, and obtain energy savings.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of an example process in a wireless device according to some embodiments of the present disclosure;

FIG. 9 is a schematic diagram of an example serving area according to some embodiments of the present disclosure; and

FIG. 10 is a flowchart of another example process of a wireless device according to some embodiments of the present disclosure.

### DETAILED DESCRIPTION

Before describing in detail example embodiments, it is noted that the embodiments reside primarily in combinations of apparatus components and processing steps related to radio resource management (RRM) reporting and/or procedures. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a” “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), JAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

“Serving cell” and “network cell” as used herein may refer to and/or include one or more cells provided by a network node 16 as described herein.

Some embodiments provide radio resource management (RRM) reporting and/procedures.

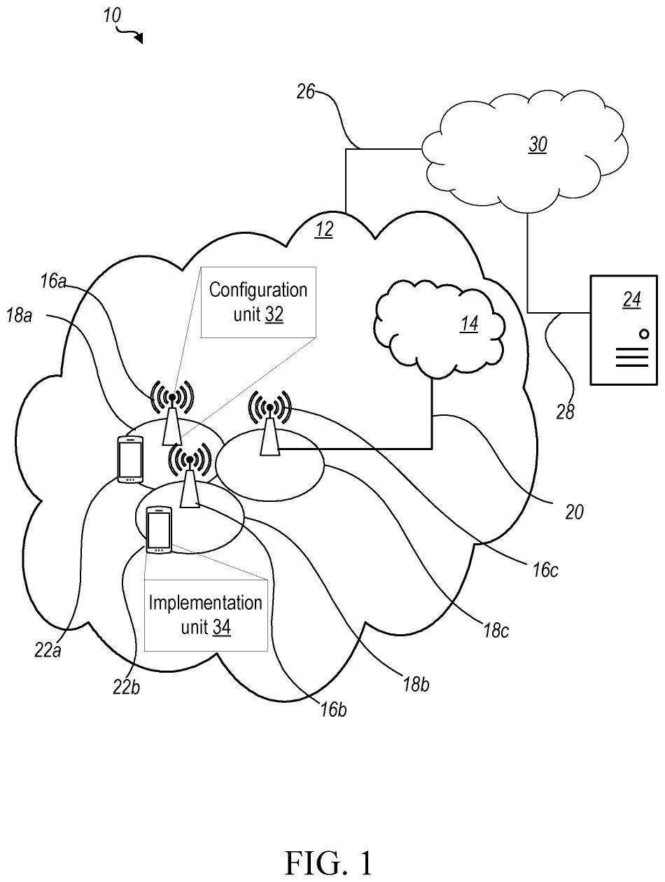

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions described herein, including functions related to, for example, RRM reporting. A wireless device 22 is configured to include an implementation unit 34 which is configured to perform one or more wireless device 22 functions described herein, including functions related to, for example, RRM reporting.

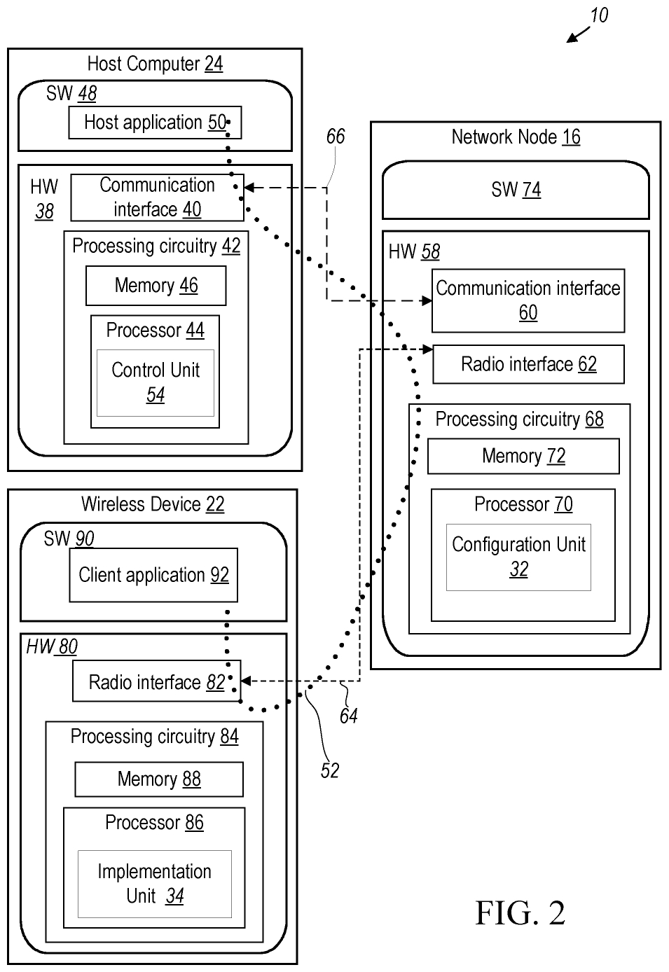

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a control unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 configured to perform one or more network node 16 functions described herein, including functions related to RRM reporting.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an implementation unit 34 configured to perform one or more wireless device 22 functions described herein, including functions related to RRM reporting.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

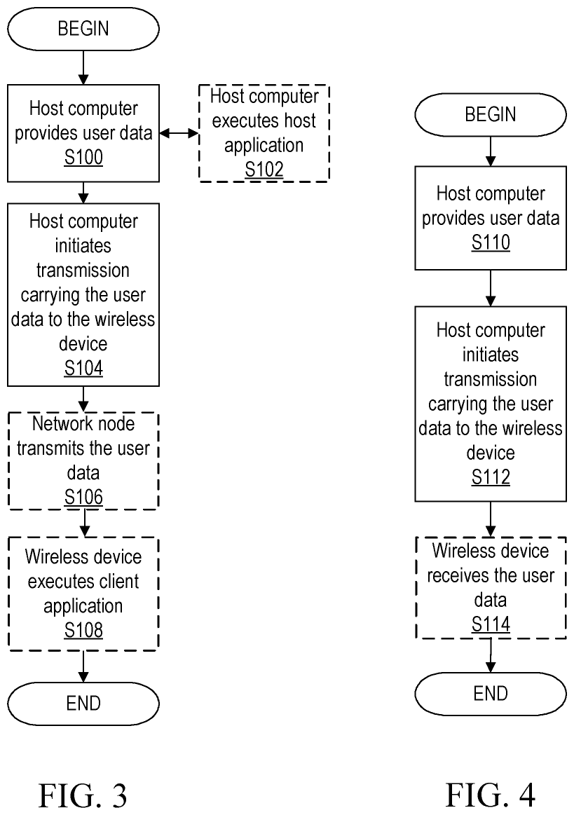

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

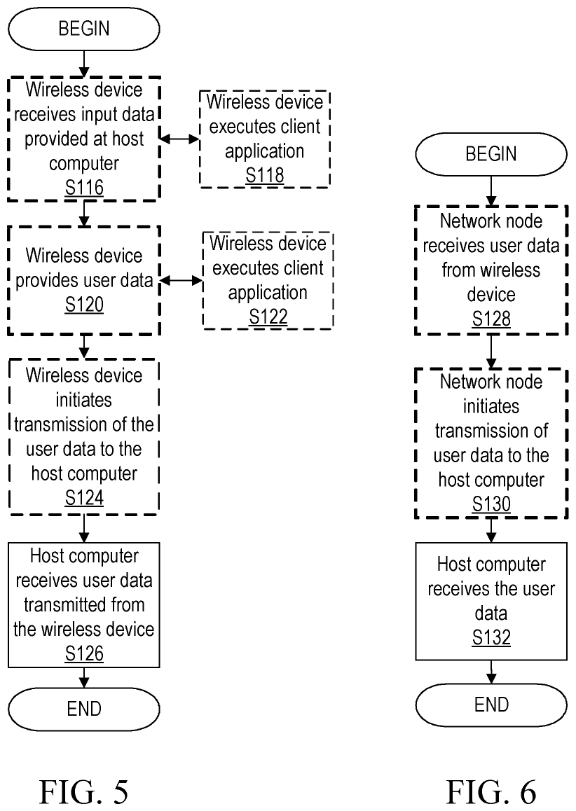

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

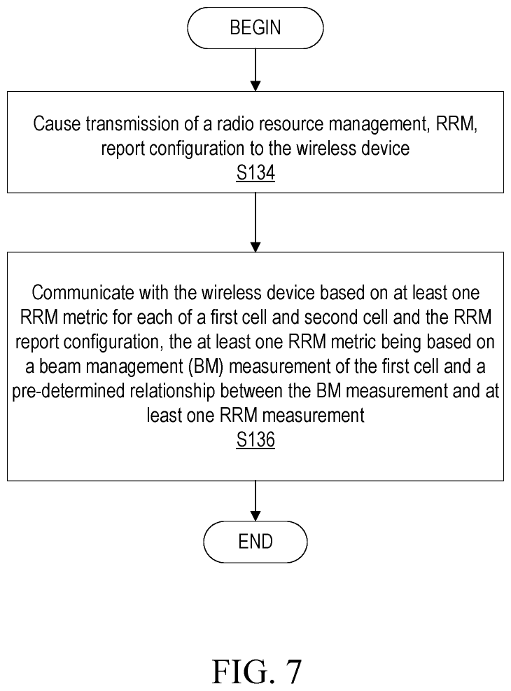

FIG. 7 is a flowchart of an example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to cause transmission of a radio resource management, RRM, report configuration to the wireless device (Block S134). The network node 16 is further configured to communicate with the wireless device 22 based on at least one RRM metric for each of a first cell and second cell and the RRM report configuration, the at least one RRM metric being based on a beam management (BM) measurement of the first cell and a pre-determined relationship between the BM measurement and at least one RRM measurement (Block S136).

In at least one embodiment, the RRM report configuration includes at least one event criterion, and the BM measurement is based on the at least one event criterion. In at least one embodiment, the network node 16 is further configured to train the wireless device 22 using predetermined measurement data.

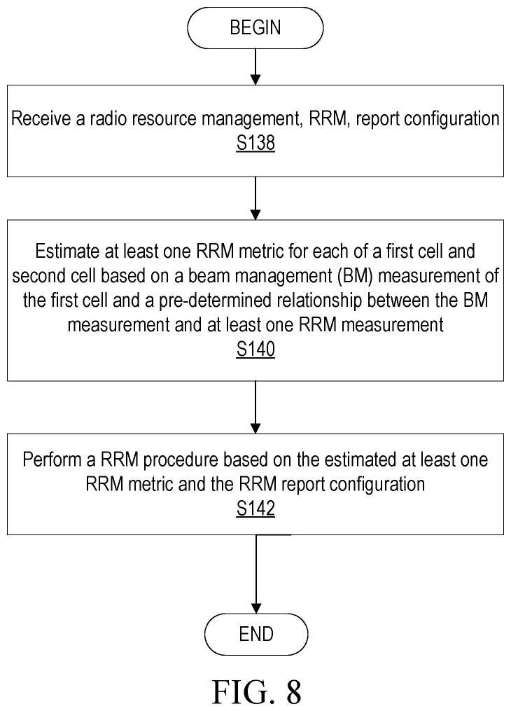

FIG. 8 is a flowchart of an example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive a radio resource management, RRM, report configuration (Block S138). Wireless device 22 is further configured to estimate at least one RRM metric for each of a first cell and second cell based on a beam management (BM) measurement of the first cell and a pre-determined relationship between the BM measurement and at least one RRM measurement (Block S140). Wireless device 22 is further configured to perform a RRM procedure based on the estimated at least one RRM metric and the RRM report configuration (Block S142).

In at least one embodiment, the RRM measurement is performed during a RRM measurement period, and the wireless device 22 is in a reduced-power state during at least a portion of the RRM measurement period. In at least one embodiment, the RRM report configuration includes at least one event criterion, and the performing of the RRM procedure is based on the at least one event criterion.

Having described the general process flow of arrangements of the disclosure and having provided examples of hardware and software arrangements for implementing the processes and functions of the disclosure, the sections below provide details and examples of arrangements for radio resource management (RRM) reporting and/or procedures.

Some embodiments provide for RRM reporting and/or procedures. One or more wireless device 22 functions described below may be performed by one or more of processing circuitry 84, processor 86, implementation unit 34, etc. One or more network node 16 functions described below may be performed by one or more of processing circuitry 68, processor 70, configuration unit 32, etc.

During a learning phase, a wireless device 22 establishes a relationship between L1 (e.g., layer 1) measurements (e.g., beam management (BM) channel state information (CSI) reference symbol (RS)) for the serving cell and/or network node and corresponding RRM measurement results (e.g., synchronization signal block (SSB)-based) for the serving and additional neighbor cells and/or network node 16. This may be achieved, e.g., by training a machine learning (ML) model or preparing/configuring/determining lookup tables.

In regular operation, the wireless device continually performs BM measurements for the serving cell and/or network node 16 and uses these reports as input (to ML inference) to estimate RRM cell/beam quality metrics for the serving and other cells and/or network node 16, or to estimate RRM event occurrences. In particular, using the ML model approach, the RRM metric prediction can include consideration of wireless device trajectory, which results in better estimates compared to traditional individual event or other RRM measurement reporting.

The wireless device 22 may be configured by the network node 16 2with conventional event-based reporting and uses the estimated RRM metrics and related event criterion evaluations as input to such RRM reporting.

In at least one embodiment, in regular operation in (typical) setups where the CSI-RS occasions are distinct from SSB occasions, the wireless device 22 may omit RRM measurements, or may perform such measurements only sparsely/occasionally. The wireless device 22 may keep at least the radio frequency (RF) stage in a low-power state during the conventional RRM measurement occasions, or at least a part of it corresponding to other other-cell measurements, and obtain energy savings.

A wireless device 22 may utilize the notion that multiple measurement procedures in the same environment typically provide related results, e.g., BM and RRM mobility measurements in a certain location will provide mutually consistent outputs. Therefore, when previous information about their relationship is available, e.g., RRM measurement results may be predicted or estimated based on BM measurements in the same region, as the BM measurements provide a higher-resolution spatial resolution from which the lower-resolution RRM-related information can be extracted.

Based on this notion, the wireless device 22 may dispense (e.g., omit, ignore, etc.) with RRM measurements and only perform BM measurements. This allows wireless device 22 energy savings since at least the RF sampling and processing circuitry may be kept in a low-power state during the SSB occasions that are generally not overlapping the BM CSI-RS occasions. The wireless device 22 may then use prior information about the BM and RRM relations to estimate the corresponding RRM measurement results and use those estimates as inputs.

The RRM event prediction is based on a previously learned relationship between BM measurements on the serving cell and RRM mobility measurements for serving and candidate network nodes16 in a certain location or along a certain route. The learning may be implemented by training, e.g., a fingerprinting-based ML model, and the estimates of RRM results in online operation are derived from inference using that model.

The RRM and BM measurements may pertain to the same band or FR, or to different bands/FRs, e.g., FR2 BM results may be used to control FR1 RRM mobility.

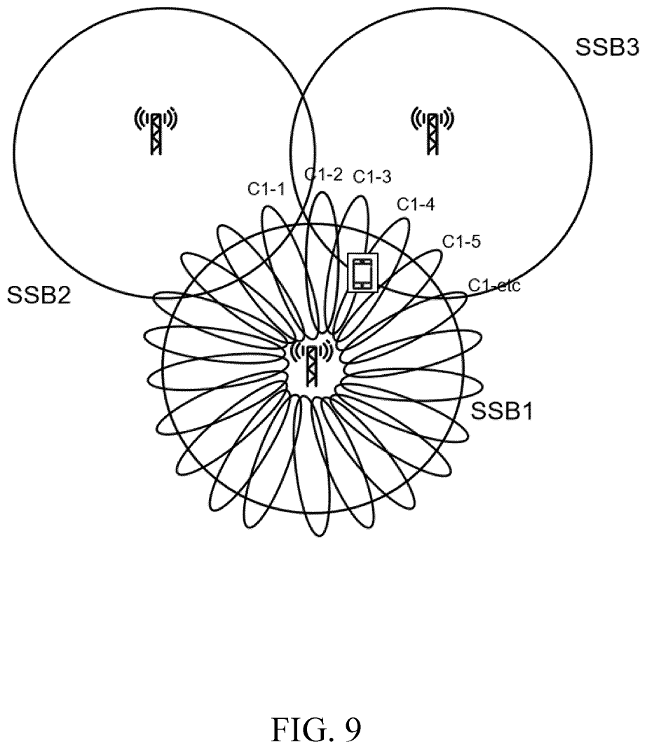

FIG. 9 is a diagram of an example of such BM-RRM relationship. In one example, respective SSBs in a cell are labeled C1-1, C1-2, etc. In the RRM mobility measurement domain, the wireless device 22 in a certain position in its serving cell 1 can be associated with SSB measurements (e.g., RSRP) for cells 1, 2, and 3. Simultaneously, in the BM measurement domain, the wireless device 22 is also associated with multiple CSI-RS metrics (e.g., L1-RSRP) in cell 1. In at least one embodiment, the RRM mobility and BM measurement fingerprints for the wireless device 22 are unique and discernible in different parts of the cell, and a certain RRM fingerprint can be linked to a BM fingerprint.

In this example, a single SSB per cell is assumed; multiple SSBs may also be provided, creating some spatial resolution which however is still coarser than captured from CSI-RS measurements.

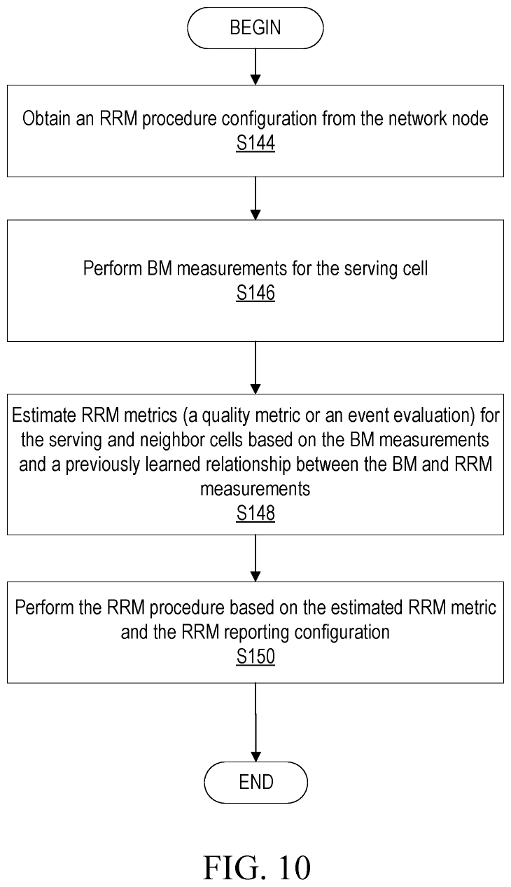

FIG. 10 is a high-level flow of a wireless device 22 implementation, according to at least one embodiment. One or more blocks described herein may be performed by one or more elements of wireless device 22 such as by one or more of processing circuitry 84 (including the implementation unit 34), processor 86, radio interface 82 and/or communication interface 60. Wireless device 22 is configured to obtain an RRM procedure configuration from the network node 16 (Block S144). The wireless device 22 receives/obtains an RRM procedure configuration via RRM signaling, including one or more of RRM measurement object description (e.g., SSBs in the serving and neighbor cells), measurement schedule, reporting event/criterion descriptions, reporting signaling configuration, conditional HO configurations, etc.

The wireless device 22 is configured to perform BM measurements for the serving cell (Block S146). The wireless device 22 performs BM L1 measurements, possibly with higher spatial resolution than the RRM measurements, according to a separately provided BM measurement configuration. The measurements may use, e.g., CSI-RS with resources included in the BM measurement configuration.

The wireless device 22 is configured to estimate RRM metrics (a quality metric or an event evaluation) for the serving and neighbor cells based on the BM measurements and a previously learned relationship between the BM and RRM measurements (Block S148). The wireless device 22 uses previously established information about the relation of BM and RRM measurement results for different possible wireless device 22 locations to derive/estimate the relevant RRM metrics from the BM measurements. In at least one embodiment, the wireless device 22 may estimate RRM measurement results for the serving cell and additional neighbor cells. In another embodiment, the wireless device 22 may estimate the occurrence of RRM events (e.g., reporting events or conditional HO trigger events) provided in the RRM procedure configuration. In at least one embodiment, the derivation/estimation may be in the form of performing ML inference using a previously trained ML model. More details about how such a model can be prepared are described herein.

The wireless device 22 is configured to perform the RRM procedure based on the estimated RRM metric and the RRM reporting configuration (Block S150). The estimated RRM metrics are used as input into the conventional RRM procedure execution, e.g., RRM reporting or triggering a conditional HO.

In one or more embodiments, Blocks S146 and S148 may be replaced by legacy RRM metric estimation based on explicit RRM measurements on the serving and/or neighbor cells.

### ML Model Training

The wireless device 22 ML model that may be used in Block S148 may be prepared by training it with measurement data from past measurement occasions. RRM measurement results for the current and neighbor cells and BM measurement results for the current cell are used as training data and the model is trained, e.g., to minimize a loss function between the observed and estimated RRM measurement results for the serving and neighbor cells when the BM measurement values are provided as input. Alternatively or additionally, the training may be designed so that the ML model generates even trigger signals for e.g., event reporting or conditional HO initiation.

In at least one embodiment, offline training is used, e.g., at the wireless device 22 vendor location, at the network node 16 vendor location, or in the network node 16. In another embodiment, online training is used where the wireless device 22 collects current measurements and trains or retrains the model for improved RRM measurement estimation.

### Additional Embodiments for Estimating RRM Metrics

The RRM metrics used in Block S148 may also be produced in other ways. In at least one embodiment, they may be produced via simulations or measurements and formulated as a lookup table. In such a solution, the BM measurement values may be used as an input parameter to the table, after optionally applying quantization, and table entries for the given input may represent corresponding RRM measurement estimates or event trigger status values or flags. The table can be generated using past BM and RRM measurement data. In one or more embodiments, the table may be stored at wireless device 22 and/or network node 16.

In at least one embodiment, the BM-RRM relationship may be formulated as a set of thresholds, where an RRM event is triggered if metrics for certain beams exceed a threshold or lie below a threshold, or similar conditions are a formulated for a combination of beams.

Other approaches for RRM metric estimation may also be envisioned and devised.

### Cell- or Site-Specific Training

In at least one embodiment, the wireless device 22 model may be trained cell-specifically. This can be achieved, e.g., in the following ways:
Local training in the wireless device 22 may be applied by wireless devices 22 that spend extended time in the cell and have a chance to explore the BM/RRM relations (e.g., perform one or more calculations, determinations, etc. related to BM/RMM relations). This may be performed by, e.g., fixed wireless devices 22 or devices used in industrial/commercial environments.
The wireless device 22 may save and retrieve previously generated models for already evaluated cells/areas. Training and model storage may be performed in the wireless device 22.
The model may be obtained by the wireless device 22 when entering the cell or a relevant region.
The model may be received OTT from a wireless device 22 vendor, where the vendor trains and provides such models based on input from many wireless devices 22. To support the training process, the wireless device 22 may provide training data to the vendor via OTT signaling.
The model may be received via Uu signaling from the network node 16, where it may be provided by the wireless device 22 vendor, operator, or the network node 16 vendor.

### Example Scenario

As a detailed example of various principles outlined in the present disclosure, the following scenario is described.

Let, in a legacy setup, the wireless device 22 be configured with RRM measurements with a 5 ms SMTC window every 80 ms in band A, and with a mobility event, causing a report to the serving network node 16 to be triggered if the difference between serving and candidate cell RSRP is less than 3 dB. The wireless device 22 thus performs measurements at the 80 ms rate and reports cases where a candidate cell is within 3 dB or less of the serving cell, and the network node 16 may determine that the wireless device 22 should perform a HO to such a candidate cell once the reported or otherwise estimated difference is less than 0 dB (i.e., the candidate cell becomes stronger than the current serving cell).

The wireless device 22 may be configured with BM measurements every 40 ms in band B, with continuous best beam and/or additional beam L1-RSRP reporting. The wireless device 22 may also be configured with RRM measurements on band A every 80 ms and a mobility event as in legacy, causing a report to the serving network node 16 to be triggered if the difference between serving and candidate cell RSRP is less than 3 dB. Using a previously trained ML model, the wireless device 22 uses the BM reports to determine that a mobility event corresponding to a certain serving/candidate cell RSRP relationship would have occurred and reports the event to the network node 16. Based on the reported event, the network node 16 may trigger a HO to the candidate cell.

The example use case provides the advantages that (1) the wireless device 22 does not need to perform RRM measurements in band A whereby the band A HW can remain in a low-power (e.g. deep sleep) state during the mobility measurement occasion, e.g., a 5 ms SMCT window and saves both active receiver operation-related and wake-up state transition energy. Additionally, (2) the HO decisions will be based on measurement data with higher spatial resolution.

### Some Examples

Example 1. A method performed in a wireless device 22 for RRM reporting to a network node 16, the method including:
obtaining an RRM reporting configuration from the network node 16,
performing one or more first L1 quality measurements for a first cell,
estimating a first RRM metric (a quality metric or an event evaluation) for the first and a second cell for the wireless device 22, based on the first L1 quality measurements and a relationship between L1 quality measurements and RRM metrics for the first cell,
performing a RRM reporting to the network node 16 based on the first RRM metric and the RRM reporting configuration.
Example 2. Example 1, and the RRM reporting configuration includes a RRM measurement occasion, and
the wireless device 22 maintains the RF stage in a reduced-power state during at least a part the RRM measurement occasion.
Example 3. Example 1, and the RRM reporting configuration includes an event criterion,
the performing the RRM reporting is based on the event criterion (i.e., following the legacy instructions).
Example 4. Example 1, and the relationship between L1 quality measurements for the first cell and first RRM quality measurements for the first cell and second cell(s) is based on a previous learning/training procedure.

One or more embodiments described herein provides one or more of the following advantages:
Omitting (or reducing) wireless device RRM measurements provides wireless device energy savings. The receiving (RX) stage may be turned off during RRM RS (e.g. SSB) time intervals.
Use of higher-resolution L1 measurements can improve event prediction accuracy and thus improves mobility robustness.
Also, reduced or omitted event-based reporting may reduce interference in the uplink (UL) and/or reduces UL resource usage for the network node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| BM | Beam Management |
| CSI | Channel State Information |
| FR | Frequency Range |
| HO | Handover |
| L1 | Layer 1 |
| ML | Machine Learning |
| RF | Radio Frequency |
| RRM | Radio Resource Management |
| RS | Reference Symbol |
| RSRP | Reference Signal Received Power |
| SMTC | SS/PBCH Block Measurement Timing Configuration |
| SSB | Synchronization Signal Block |
| TTPEP | Time To Predicted Event |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### Example Embodiments

Embodiment A1. A network node configured to communicate with a wireless device (WD), the network node configured to, and/or comprising a radio interface and/or comprising processing circuitry configured to:
cause transmission of a radio resource management, RRM, report configuration to the wireless device; and
communicate with the wireless device based on at least one RRM metric for each of a first cell and second cell and the RRM report configuration, the at least one RRM metric being based on a beam management (BM) measurement of the first cell and a pre-determined relationship between the BM measurement and at least one RRM measurement.
Embodiment A2. The network node of Embodiment A1, wherein the RRM report configuration includes at least one event criterion, and the BM measurement is based on the at least one event criterion.
Embodiment A3. The network node of Embodiment A1, wherein the processing circuitry is further configured to train the wireless device using predetermined measurement data.
Embodiment B1. A method implemented in a network node, the method comprising:
causing transmission of a radio resource management, RRM, report configuration to the wireless device; and
communicating with the wireless device based on at least one RRM metric for each of a first cell and second cell and the RRM report configuration, the at least one RRM metric being based on a beam management (BM) measurement of the first cell and a pre-determined relationship between the BM measurement and at least one RRM measurement.
Embodiment B2. The method of Embodiment B1, wherein the RRM report configuration includes at least one event criterion, and the BM measurement is based on the at least one event criterion.
Embodiment B3. The method of Embodiment B1, further comprising training the wireless device using predetermined measurement data.
Embodiment C1. A wireless device (WD) configured to communicate with a network node, the WD configured to, and/or comprising a radio interface and/or processing circuitry configured to:
receive a radio resource management, RRM, report configuration;
estimate at least one RRM metric for each of a first cell and second cell based on a beam management (BM) measurement of the first cell and a pre-determined relationship between the BM measurement and at least one RRM measurement; and
perform a RRM procedure based on the estimated at least one RRM metric and the RRM report configuration.
Embodiment C2. The WD of Embodiment C1, wherein the at least one RRM measurement is performed during a RRM measurement period; and
the wireless device being in a reduced-power state during at least a portion of the RRM measurement period.
Embodiment C3. The WD of Embodiment C1, wherein the RRM report configuration includes at least one event criterion; and
the performing of the RRM procedure is based on the at least one event criterion.
Embodiment D1. A method implemented in a wireless device (WD), the method comprising:
receiving a radio resource management, RRM, report configuration;
estimating at least one RRM metric for each of a first cell and second cell based on a measured beam characteristic of the first cell and a pre-determined relationship between the measured beam characteristic and at least one RRM measurement; and
performing a RRM procedure based on the estimated at least one RRM metric and the RRM report configuration.
Embodiment D2. The method of Embodiment D1, wherein the at least one RRM measurement is performed during a RRM measurement period; and
the wireless device being in a reduced-power state during at least a portion of the RRM measurement period.
Embodiment D3. The method of Embodiment D1, wherein the RRM report configuration includes at least one event criterion; and
the performing of the RRM procedure is based on the at least one event criterion.

1. A network node configured to communicate with a wireless device, WD, the network node comprising a radio interface and processing circuitry configured to:
cause transmission of a radio resource management, RRM, report configuration to the WD; and
communicate with the WD based on at least one RRM metric for each of a first cell and second cell and the RRM report configuration, the at least one RRM metric being based on a Layer 1, L1, measurement of the first cell and a pre-determined relationship between the L1 measurement and at least one RRM measurement.

2. The network node of claim 1, wherein the L1 measurement comprises a beam management, BM, measurement.

3. The network node of claim 1, wherein the RRM report configuration includes at least one event criterion, and the L1 measurement is based on the at least one event criterion.

4. The network node of claim 1, wherein the processing circuitry is further configured to train the wireless device using predetermined measurement data.

5. A method implemented in a network node, the method comprising:
causing transmission of a radio resource management, RRM, report configuration to a wireless device; and
communicating with the wireless device based on at least one RRM metric for each of a first cell and second cell and the RRM report configuration, the at least one RRM metric being based on a Layer 1, L1, measurement of the first cell and a pre-determined relationship between the L1 measurement and at least one RRM measurement.

6. The method of claim 5, wherein the L1 measurement comprises a beam management, BM, measurement.

7. The method of claim 5, wherein the RRM report configuration includes at least one event criterion, and the L1 measurement is based on the at least one event criterion.

8. The method of claim 5, further comprising training the wireless device using predetermined measurement data.

9. A wireless device, WD, configured to communicate with a network node, the WD comprising a radio interface and processing circuitry configured to:
receive a radio resource management, RRM, report configuration;
estimate at least one RRM metric for each of a first cell and second cell based on a Layer 1, L1, measurement of the first cell and a pre-determined relationship between the L1 measurement and at least one RRM measurement; and
perform a RRM procedure based on the estimated at least one RRM metric and the RRM report configuration.

10. The WD of claim 1, wherein the L1 measurement comprises a beam management, BM, measurement.

11. The WD of claim 9, wherein the at least one RRM measurement is performed during a RRM measurement period; and
the WD being in a reduced-power state during at least a portion of the RRM measurement period.

12. The WD of claim 9, wherein the RRM report configuration includes at least one event criterion; and
the performing of the RRM procedure is based on the at least one event criterion.

13. A method implemented in a wireless device, WD, the method comprising:
receiving a radio resource management, RRM, report configuration;
estimating at least one RRM metric for each of a first cell and second cell based on a measured Layer 1, L1, quality of the first cell and a pre-determined relationship between the measured L1 quality and at least one RRM measurement; and
performing an RRM procedure based on the estimated at least one RRM metric and the RRM report configuration.

14. The method of claim 13, wherein the L1 quality comprises a beam characteristic.

15. The method of claim 13, wherein the at least one RRM measurement is performed during a RRM measurement period; and
the WD being in a reduced-power state during at least a portion of the RRM measurement period.

16. The method of claim 13, wherein the RRM report configuration includes at least one event criterion; and
the performing of the RRM procedure is based on the at least one event criterion.

17. The method of claim 6, wherein the RRM report configuration includes at least one event criterion, and the L1 measurement is based on the at least one event criterion.

18. The method of claim 6, further comprising training the wireless device using predetermined measurement data.

19. The method of claim 14, wherein the at least one RRM measurement is performed during a RRM measurement period; and
the WD being in a reduced-power state during at least a portion of the RRM measurement period.

20. The method of claim 14, wherein the RRM report configuration includes at least one event criterion; and
the performing of the RRM procedure is based on the at least one event criterion.
